(19) United States
(12) Patent Application Publication
(10) Pub. No.: US 2008/0081318 A1
(43) Pub. Date: Apr. 3, 2008

(54) PRELAYERED DENTAL APPLIANCES, KITS, AND METHODS FOR PROVIDING CONSISTENT SHADE MATCHING

(75) Inventor: Dan E. Fischer, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/537,357

(22) Filed: Sep. 29, 2006

(51) Int. Cl. A61C 5/08; A61C 5/10; A61C 13/08

(52) U.S. Cl. 433/222.1; 433/223; 433/203.1; 264/19

(57) ABSTRACT

Prefabricated non-custom dental appliances, kits, and methods that allow a practitioner to select one or more prefabricated non-custom appliances having desired color shading characteristics from a kit and bond the selected appliances to a person's teeth. Each appliance includes a form layer including a surface contoured so as to approximate a tooth surface (e.g., the labial surface shape of a selected tooth). The appliance includes a plurality of at least partially uncured composite layers or regions. At least one of the composite layers or regions is disposed adjacent to the form layer, and each region is prearranged relative to one another so as to provide a predetermined overall color shade configuration. At least one of the composite layers or regions differs in color from at least one other composite region so as to provide a desired shade and intensity to the dental appliance.

### BACKGROUND OF THE INVENTION

1. The Field of the Invention

The present invention is in the field of dental appliances (e.g., crowns, bridges, veneers, etc.). More particularly, the invention is directed to prefabricated, non-custom dental appliances which can be mass produced and which provide for improved and consistent shade matching between the dental appliance and adjacent natural teeth and/or additional dental appliances installed simultaneously.

2. The Relevant Technology

Currently, dental appliances are custom prepared by a dental practitioner or trained dental technician. The preparation of any such appliance is an elaborate multi-step process. In one such process, the teeth are prepared and an impression is then taken of the patient's teeth, which allows the practitioner or technician to create a custom model of the patient's teeth. The practitioner may then fabricate a custom appliance, although more typically the custom model is sent to a separate dental lab specializing in custom appliance fabrication. The custom model is accompanied by a description of the appropriate color shade for the appliance to be manufactured. A custom appliance (e.g., fabricated of porcelain, composite, or porcelain fused to metal) may then be fabricated from scratch by a technician. During the fabrication process, the technician attempts to fabricate the custom appliance in shades that will match the surrounding teeth and/or any adjacent appliances once installed. For example, the occlusal edge of a natural tooth is typically at least somewhat translucent to visible light because of the light transmission characteristics of tooth enamel, while the more central portions of the tooth are typically relatively more opaque due to the presence of tooth dentin and/or pulp located within the interior of the tooth. In addition, most teeth are not naturally bright white, but rather include some natural color shading. Shading is provided through the use of materials and/or pigments providing different shading and coloring characteristics to the finished appliance. This can be particularly difficult because the patient is typically not available during this process (i.e., it is performed at a separate location by a specialized dental technician or at a later time by the dental practitioner), with the only guidance being the description of the appropriate color shade provided to the dental lab or recorded by the dental practitioner. In addition, enamel and dentin vary in degree of translucency, opacity and shading, from one tooth to another, and sometimes even across a single tooth. Such characteristics are further affected by the depth and thickness of the tooth. These types of characteristics are virtually impossible to communicate to a laboratory technician.

Furthermore, the process of manufacturing a custom dental appliance is highly labor-intensive. Many steps in the process require highly skilled labor which results in a relatively high cost for the finished product. In particular, fabricating the appliance so that it appears authentic (i.e., including a realistic degree of translucence near the occlusal edges, providing a realistic color shade, realistically blending the edges of one color shade into another) requires a dental professional or technician who is both experienced and skilled in this art and has artistic ability (it is for this reason that fabrication is typically performed at a separate facility by dental technicians who are highly skilled and experienced in this highly specialized field).

One particular problem, as described above, is the difficulty of achieving consistent shade matching to adjacent natural teeth, particularly when the patient's teeth are not available for reference during actual manufacture of the custom appliance. Another particular problem is achieving consistent shade matching across multiple appliances to be installed adjacent to each other. Even for a highly skilled practitioner or technician, it can be nearly impossible to custom fabricate multiple appliances that consistently match in shade from one appliance to the next. In other words, any custom appliance is its own unique custom work of art, different from any other. This difficulty is particularly pronounced when the appliances are to be installed on adjacent teeth that are particularly visible, for example, two or more of the upper or lower incisors. Because the incisors are most often seen (e.g., every time the person smiles), even a small degree of unnatural appearance or shade mismatching between veneers or other appliances installed on these teeth (particularly the upper incisors) can be very undesireable, even affecting the self-confidence of the patient.

Besides being labor-intensive, the process is time-intensive. Many of the steps in the process are typically performed at a facility separate from the dentist's office (e.g., a dental lab). While this is advantageous in that it allows for fabrication by experienced and highly skilled technicians, it also requires the patient to return to the dentist's office multiple times in order to make the necessary impression, determine the desired shading characteristics, and return (perhaps one or two weeks later) to install the custom appliance. With this technique there is also a relatively high probability (no matter how much care is taken to avoid it) that the custom fabricated appliance does not match well with the patient's natural adjacent teeth and/or other appliances to be installed, requiring further delay while replacement custom appliances are ordered and fabricated.

In view of the foregoing, it would be an improvement in the art to provide a prefabricated non-custom appliance system (i.e., an off the rack system) that would allow the dental practitioner of even average skill to achieve very good shade matching, even when installing multiple adjacent appliances. Such a system would further reduce the amount of labor and time required as compared to techniques involving the fabrication of custom appliances. The whole process could easily be completed in a single appointment, which would result in a tremendous savings of time and money for both the dental practitioner and the patient. In addition, such a system would often reduce the need to remove so much of the natural tooth tissue as compared to existing custom techniques and systems, which allows the patent to retain more of the natural tooth structure (including its natural coloring). At the same time, the system would optionally allow some degree of customization via manipulation of the appliance prior to final installation and/or filling and/or luting resins used chair-side.

### BRIEF SUMMARY OF THE INVENTION

The present invention is directed to prefabricated non-custom dental appliances, and related methods and kits that allow a dental practitioner to bond one or more selected prefabricated, non-custom dental appliances to a person's tooth. In one example, the inventive appliance includes a transparent or translucent form layer configured to provide a contoured shape that approximates a tooth surface. For example in the case of a veneer, the form layer provides a contoured surface shape approximating the labial surface of a selected tooth (e.g., an upper first left incisor). The appliance also includes a plurality of composite layers or regions that are at least partially uncured. At least one of the composite layers or regions differs in color from at least one other composite layer or region once all composite layers or regions are fully cured. At least one composite layer or region is disposed adjacent to the form layer, and each layer or region is prearranged relative to one another and the form layer so as to provide a desired overall appearance, shade, and intensity having a natural-like polychromatism. Because the composite layers are at least partially uncured, they may be manipulated for a degree of customization chair-side by the practitioner, if desired. Such an option may be used chair-side to provide even better shade matching and more improved natural appearance, as it allows (but does not require) the practitioner to manipulate the off the rack system according to the characteristics of adjacent natural teeth and/or appliances.

An inventive kit containing multiple prefabricated non-custom dental appliances with different characteristics (e.g., each providing a different shading and/or intensity configuration) advantageously allows a dental practitioner to select an appropriate appliance from the kit. The particular appliance is selected (and optionally further manipulated) so as to provide a desired color shade and intensity to a particular tooth once installed. The particular appliance is also selected for its ability to provide consistent shade matching to adjacent natural teeth and/or to any additional appliances to be installed at the same time. The selected one or more prefabricated non-custom appliances can be selected, manipulated, and bonded in a single appointment. Furthermore, the prefabricated non-custom appliances eliminate the need to completely custom form an appliance, which is inherently difficult, and by which process it is nearly impossible to achieve consistent matching of the custom appliance relative to adjacent natural teeth and/or any additional adjacent appliances to be installed.

The plurality of composite layers or regions may be partially cured so as to provide increased viscosity, which prevents the plurality of composite layers or regions from slumping. Such partial curing is particularly beneficial as it is expected that the appliances will be packaged, stored, and shipped after manufacture, which otherwise may cause the composite layers or regions to slump over time. Partial curing also helps the composite layers or regions retain any manipulation of the composite performed by the practitioner immediately prior to installation. Partial curing acts to increase the viscosity of the composite materials. Alternative means for increasing the viscosity may include use of more viscous resin components and/or use of resins having a greater fraction of filler so as to increase viscosity. Highly filled resins may also advantageously lend greater strength and hardness to the finished restoration. Furthermore, only partially curing the composite during manufacture allows the dental practitioner to later fully cure the composite layers or regions during the installation and bonding process.

Preferably, at least one composite region is at least somewhat translucent to visible light once fully cured. The translucency of such a region mimics the translucency and color of natural tooth enamel. For example, such a region may be applied adjacent the form layer so as to form the occlusal (e.g., incisal) edge and/or exposed labial surface of the appliance. According to one exemplary embodiment, other composite layers or regions may be of a red brown shade, a red yellow shade, a gray shade, or a reddish gray shade once fully light cured. In a typical example, a continuous semi-translucent varyingly tinted milky-white layer forms the labial surface of the finished appliance after installation (i.e., is disposed so as to contact the form layer, which is later removed), while another composite region of a desired shade is disposed adjacent the semi-translucent composite region.

As suggested above, the invention also relates to a kit for use in bonding one or more prefabricated non-custom dental appliances as described above. The kit advantageously includes a plurality of prefabricated appliances having different shading characteristics, which allows the dental practitioner to select an appropriate appliance based upon a knowledge of the tooth to which the appliance is to be bonded, and on the shading of adjacent natural teeth and/or any additional appliances to be installed adjacent to the selected appliance. Such a kit is highly advantageous as it provides for excellent and consistent shade matching across multiple appliances to be installed adjacent to one another (e.g. four veneers to be installed over a person's four adjacent upper incisors). As each appliance is prefabricated under controlled mass production conditions (as opposed to individually custom manufactured in a dental lab), consistent shade matching across multiple appliances is much easier to achieve, even for a practitioner of average or even below average skill, because all that is required is to identify the shades desired, select the corresponding appliances, prepare the tooth surfaces for installation, and bond the selected appliances to the prepared tooth surfaces.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary embodiment of a prefabricated non-custom veneer appliance;

FIG. 1B is a cross-sectional view of the veneer appliance of FIG. 1A;

FIG. 2 is a perspective view of an exemplary kit including a plurality of prefabricated non-custom veneer appliances;

FIG. 3A is a perspective view of a plurality of a person's teeth identified for installation of prefabricated non-custom dental veneer appliances;

FIG. 3B illustrates each prepared tooth surface of FIG. 3A having been etched, primed, a bonding resin applied to the prepared tooth surface, and the bonding resin being cured by exposure to curing light wavelengths;

FIG. 3C illustrates a plurality of prefabricated non-custom dental veneer appliances selected from the kit of FIG. 2 being positioned against the prepared tooth surfaces of FIG. 3B, and the appliances being exposed to curing light wavelengths so as to fully cure the plurality of composite layers or regions and bond the appliances to the person's teeth; and

FIG. 3D illustrates the transparent or translucent form layers being removed from each appliance.

### DETAILED DESCRIPTION OF THE PREFERRED EMBODIMENTS

### I. Introduction

The present invention is directed to prefabricated non-custom dental appliances, and related kits and methods that allow a dental practitioner to select one or more prefabricated non-custom dental appliances having desired color shading characteristics from a kit and bond the selected appliances to a person's teeth. The inventive appliance includes a transparent or translucent form layer configured to provide a contoured shape that approximates a tooth surface (e.g., the labial surface shape of a selected tooth). The appliance advantageously includes a plurality of composite layers or regions that are at least partially uncured. At least one of the composite layers or regions is disposed adjacent to the form layer, and each layer or region is prearranged relative to one another so as to provide a predetermined overall color shade configuration. At least one of the composite layers or regions differs in color from at least one other composite layer or region once fully cured so as to provide a desired shade to the dental appliance in order to create an overall desired appearance to the appliance.

There are a number of color shade systems for characterizing the color shade of a natural tooth or an appliance. One such system is the VITA LUMIN-SHADE GUIDE, which contains 4 basic color groups (identified as A, B, C, and D) and several degrees of intensity within each basic color group for a total of 16 color shade/intensity designations. In this system, the color group A designates red-brown and includes intensities A1, A2, A3, A3.5, and A4. Color group B designates red-yellow and includes intensities B1, B2, B3, and B4. Color group C designates gray and includes intensities C1, C2, C3, and C4. Color group D designates reddish gray and includes intensities D2, D3, and D4. The lower a number in any given color group, the less intense the color. In other words, an A2 shade is a more intense red-brown than an A1 shade. Colors and intensities of the VITA system will be used in the discussion below, although it is to be understood that other systems may be used within the scope of the invention. For example, with regard to enamel, materials used to replace missing enamel are typically semi-translucent milky white tints of varying opacity, translucency, and chroma.

### II. Exemplary Prefabricated Non-Custom Dental Appliances

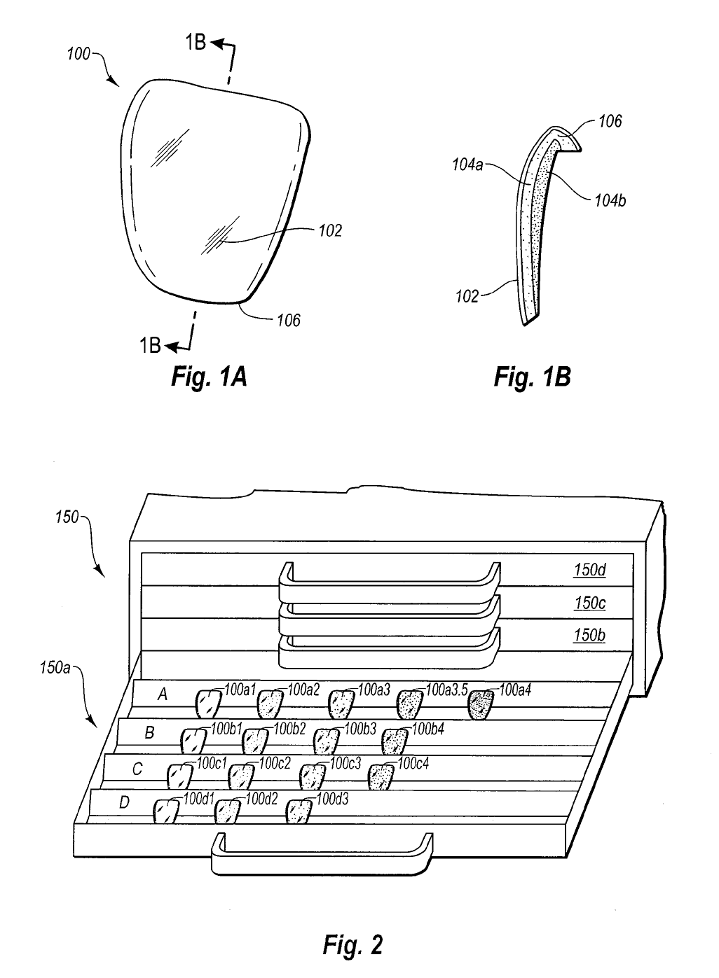

FIG. 1A is a perspective view of an exemplary prefabricated non-custom dental appliance 100, while FIG. 1B shows a cross-sectional view of appliance 100. Non-custom appliance 100 includes a transparent or translucent form layer 102 and a plurality of composite layers or regions. The illustrated embodiment advantageously includes two composite layers or regions 104a and 104b, respectively. The transparent or translucent form layer 102 provides a contoured shape approximating a predetermined, desired shape of a tooth surface. Appliance 100 is an example of a veneer appliance, designed for placement over a labial facing prepared tooth surface. For example, in the illustrated embodiment, an inside surface of form layer 102 (against which composite layer or region 104a is disposed) approximates the labial tooth profile, surface, and shape of an upper first left incisor. Other veneer appliances may include a form layer that approximates the labial tooth surface of another desired tooth (e.g., one of the other upper or lower incisors, one of the upper or lower canines, one of the upper or lower bicuspids, or one of the upper or lower molars).

Exemplary appliance 100 may have a total thickness of about 1-2 mm, with composite layers or regions 104a and 104b comprising most of this (e.g., between about 0.95 mm and about 1.95 mm). Transparent or translucent form layer 102 is preferably thin, having a thickness between about 0.05 mm and about 0.5 mm, more preferably between about 0.1 mm and about 0.25 mm. Form layer 102 includes an interior surface shaped so as to provide a desired form, contour, and profile to the underlying composite layer or region 104a, while also being transparent or translucent to at least curing light wavelengths so as to allow for light curing of the underlying composite layers or regions through form layer 102.

Transparent or translucent form layer 102 may be formed of any suitable material (e.g., mylar, celluloid, a plastic, or gelatin) that is transparent or translucent to curing light wavelengths, that is sufficiently rigid so as to hold its shape, and that can be easily removed from the composite layers or regions once the composite layers or regions are fully cured (i.e., the form layer does not strongly bond to the composite layers or regions). In one embodiment, the form layer 102 may simply comprise a portion of underlying composite layers or regions having sufficient rigidity so as to hold the necessary shape (e.g., the outwardly exposed portion of the composite may be partially cured to a sufficient degree so as to have the necessary rigidity), and the form layer portion must also sufficient transmission of curing light wavelengths so as to allow curing of the remainder of the underlying composite layers or regions. Of course, in such an embodiment it is not necessary to be able to remove the form layer as the form layer itself comprises a portion of the underlying composite layers or regions.

Transparency or translucency of form layer 102 to broad spectrum visible light (i.e., white light) also advantageously allows the dental practitioner to see through the form layer 102, making the overall shading characteristics of the underlying composite layers or regions easily apparent to the practitioner. This can be helpful, particularly when multiple appliances having different shade characteristics are stored together as it simplifies identification, classification, and separation of the various appliances if they become inter-mixed.

First composite region 104a comprises a layer disposed adjacent to transparent or translucent form layer 102. First composite layer or region 104a is advantageously translucent or semi-translucent to visible light so as to mimic the translucency of natural tooth enamel. In one embodiment, the first composite layer or region 104a may be translucent and milky-white in color. To more closely mimic the look of a natural tooth, first composite layer or region 104a is advantageously disposed within those locations occupied by tooth enamel in a natural tooth. For example, composite layer or region 104a not only occupies the space adjacent to form layer 102 that corresponds to the labial surface of the appliance, but also forms the occlusal edge 106 of appliance 100. Such placement of composite layer or region 104a is advantageous as it mimics the location, translucency, and look of natural enamel. Although translucent, layer or region 104a may also advantageously include some color (i.e., a milky white tint similar to natural tooth enamel) as well.

Second composite layer or region 104b is of a color different from translucent composite layer or region 104a. For example, if the appliance is to have an overall VITA LUMIN basic shade of A (e.g., any of shade intensities A1, A2, A3, A3.5 or A4), layer or region 104b may include a red-brown pigment. The composite material includes a concentration of pigment so as to provide the desired intensity of red-brown color. The pigment concentration for any of shades A-D typically ranges between about 0.01 percent and about 3 percent by weight, more typically between about 0.1 and about 2 percent by weight, and most typically between about 0.25 and about 1 percent by weight.

The concentration of pigment present depends on the intensity desired. For example, an appliance having an A3 intensity will have a higher concentration of pigment than an appliance having an A2 shade. Similarly, an appliance designed to have an overall VITA LUMIN basic shade of B includes a pigment within second composite layer or region 104b that is red-yellow in color, an appliance designed to have an overall VITA LUMIN basic shade of C includes a pigment within second composite layer or region 104b that is gray in color, and an appliance designed to have an overall VITA LUMIN basic shade of D includes a pigment within composite layer or region 104b that is reddish-gray in color. Of course, it is within the scope of the invention for an appliance to include additional composite layers or regions so as to provide additional intermediate shades (e.g., an appliance including both an A2 shade/intensity layer or region and a B3 shade/intensity layer or region) to provide greater tooth-matching capability, although it is contemplated that kits including the basic 4 shades and 16 intensities will provide a sufficient degree of variety to the dental practitioner for typical uses, while also minimizing manufacturing costs since only 16 intensities are required in such a kit.

The composite layers or regions 104a and 104b may comprise any light curable composite material that is non-toxic when used within the oral cavity. Exemplary composites include a base resin material, optionally a filler, optionally one or more pigments, and a photoinitiator. Exemplary base resin materials include, but are not limited to bisphenol A diglycidyl dimethacrylate (Bis-GMA), triethyleneglycol dimethacrylate (TEG-DMA), urethane dimethacrylate (UDMA), glycidyl methacrylate (GMA). The above base resin materials are particularly preferred because of their relatively high viscosity, which aids in prevention of slumping of the composite layers or regions. Additional lower viscosity resin materials may also be included, for example, 2-hydroxyethyl methacrylate (HEMA) and/or ethoxylated bisphenol A dimethacrylate (Bis-EMA). One or more of the included resin materials may advantageously be phosphated, which decreases surface tension and improves the dispersion of any fillers included within the composite material. It may also enhance adhesion to teeth, which are calcified and therefore hydrophilic.

Optional fillers may advantageously include reinforcing glass or ceramic fibrous fillers or particulate fillers. Glass or ceramic fiber fillers may typically have a fiber length between about 10 and about 20 microns and a diameter of less than about 1 micron, preferably less than about 0.75 micron and more preferably less than about 0.5 micron. The inclusion of submicron glass or ceramic fibers advantageously provides for reinforcement of the composite layers or regions, while the small fiber diameter (e.g., less than about 1 micron, less than about 0.75 micron, less than about 0.5 micron) reduces any tendency for the fibers to create shards or otherwise sharp ends that would be uncomfortable to the patient.

One particularly advantageous particulate filler is fumed silica, which may be included to increase the viscosity of the at least partially uncured composite layers or regions, so as to reduce or eliminate any tendency for the composite layers or regions to slump, which can be particularly problematic during shipping or storage. The inclusion of fillers may also advantageously lend greater strength and hardness to the finished restoration.

Pigments may also be included, particularly within the colored second composite layer or region 104b (as compared to translucent composite layer or region 104a, which may advantageously include little or no pigment). Exemplary pigments include iron oxide, titanium dioxide, and other pigments known in the art (e.g., any food grade colorant or pigment may be used). Iron oxide type pigments may be particularly useful in making red-brown, red-yellow, red, and/or brown color shaded pigments.

Exemplary photoinitiators include camphorquinone, phenolpropanedione, and IRGACURE, sold by Ciba Specialty Chemicals, of Basel, Switzerland.

Composite layers or regions 104a and 104b may be partially cured so as to increase the viscosity of the composite, preventing or minimizing slumping of the composite layers or regions, which might otherwise occur. Such a partial curing is particularly beneficial as it is expected that the appliances will be packaged, stored, and shipped after manufacture, which otherwise may result in slumping of the composite over time. In addition, the increased viscosity helps the composite layers or regions retain any manipulation of the composite performed by the practitioner immediately prior to installation and bonding. Alternatively, a particulate filler that also acts as a thickener, such as fumed silica, may be added to the composite to increase viscosity.

The prefabricated non-custom appliances are advantageously manufactured in a controlled mass production manufacturing environment. Because the appliances are mass produced under controlled conditions, it is possible to fabricate identical appliances, and perhaps more importantly, appliances configured for placement on adjacent teeth, and that consistently match from one to another in shade and intensity. For example, a veneer appliance configured for placement over an upper first left incisor includes an appropriately formed transparent or translucent form layer with an interior surface that mimics the shape and contour of the labial surface of an upper first left incisor, along with two or more composite layers or regions of at least two different colors in a predetermined arrangement so as to provide a desired shade and intensity to the veneer appliance. A veneer appliance configured for placement over an upper second left incisor can also be manufactured so as to have the necessary slightly different shape (provided by the interior surface of another transparent or translucent form layer), but that may also include two or more composite layers or regions of at least two different colors in a predetermined arrangement so as to provide a shade and intensity that matches that of the veneer appliance configured for adjacent placement on the upper first left incisor. The result of such a system is that when multiple teeth are covered, human error and/or inconsistency is reduced or eliminated so as to facilitate a more natural looking consistent result for all of the teeth.

More generally, a transparent or translucent form layer is formed (e.g., by injection molding, thermoforming, or vacuum forming) so as to have an inside contoured surface approximating a tooth surface (e.g., the labial surface of a specific tooth). An arrangement of two or more composite layers or regions of different colors is determined and selected that will provide an overall desired shade and intensity to the appliance. The multiple composite layers or regions are applied over the transparent or translucent form layer in the predetermined configuration. At least one of the layers or regions is applied adjacent the transparent or translucent form layer, and as mentioned above, at least one of the layers or regions differs in color from at least one other layer or region. The plurality of layers or regions are applied according to the predetermined arrangement so as to provide a desired shade, intensity, and overall appearance, the effect of which is to mimic or approximate the appearance, shade, and shade intensity of a natural tooth surface.

In one embodiment, the appliances may be manufactured by forming a plurality of form layers (e.g., by thermoforming, stamping, vacuum forming, or combinations thereof) within a single sheet of suitable substrate material (e.g., a transparent plastic). In other words, the sheet substrate material may have a plurality of depressed troughs (each trough corresponding to a form layer) formed into its surface. A first composite layer or region may be applied (e.g., brushed, sprayed, or painted on) adjacent each form layer, which may be subsequently partially cured so as to provide a sufficient degree of viscosity and body to the composite layer or region so as to prevent slumping. A second composite layer or region may then be applied adjacent each first composite layer or region, which may subsequently be partially cured in a similar manner. Individual appliances may then be separated from the sheet by cutting out around each form layer. Alternatively, the transparent form layers may be cut from the sheet prior to application of the first and second composite layers or regions, although keeping the sheet intact during application of the first and second composite layers or regions may advantageously be more efficient from a manufacturing perspective as it requires handling of only one relatively large sheet during application of the composite layers or regions rather than handling each form layer separately.

According to another method, a first composite layer may be applied (e.g., brushed, sprayed, or painted on) over the full surface of a sheet of material (e.g., transparent plastic) into which will be formed a plurality of transparent form layers. The first composite layer may be partially cured, and a second composite layer may then be applied over the first composite layer, which is subsequently partially cured. Partial curing provides body and a sufficient degree of viscosity to the composite layers so as to prevent slumping. The sheet of material and the applied composite layers may then be shaped (e.g., by thermoforming, stamping, vacuum forming, or combinations thereof) so as to form a plurality of form layers into the sheet substrate having the desired tooth shape. Because of the soft, not fully cured properties of the composite layers, the composite layers take the shape of the shaped form layer. In other words, during the shaping process, the first and second composite layers remain intact, adjacent to the underlying sheet substrate material into which the plurality of form layers have been formed, assuming the shape and contours of the form layers.

A separate and removable form layer is not necessarily required. In one embodiment, the form layer simply comprises a portion of the composite layers or regions having sufficient rigidity (e.g., through partial curing) to perform the function of a separate and removable form layer. In other words, the form layer maintains a surface contour that approximates the desired tooth surface without any external support, and even when subjected to moderate disruptive forces (e.g., for example the form layer will not be substantially deformed under its own weight or other forces typically encountered during storage and/or shipping). According to one such method of manufacture, composite layers may be applied into any of the molding form layers described above (e.g., a plastic sheet with troughs formed therein), and the molding form layer may be removed at any time after the portion of the composite layer is able to act as the form layer (e.g., after partial curing), as the labial surface (i.e., to be outwardly exposed) of the composite layer has sufficient rigidity to act as a form layer.

Because the appliances are non-custom and are mass produced under controlled conditions, it is possible to produce exact duplicates. Furthermore, it is possible to produce appliances configured for placement adjacent to one another (e.g., a veneer appliance for a lower second left incisor and a veneer appliance for an adjacent lower left canine) that provide consistent shade matching once installed adjacent to each other.

### III. Exemplary Kits and Methods of Use

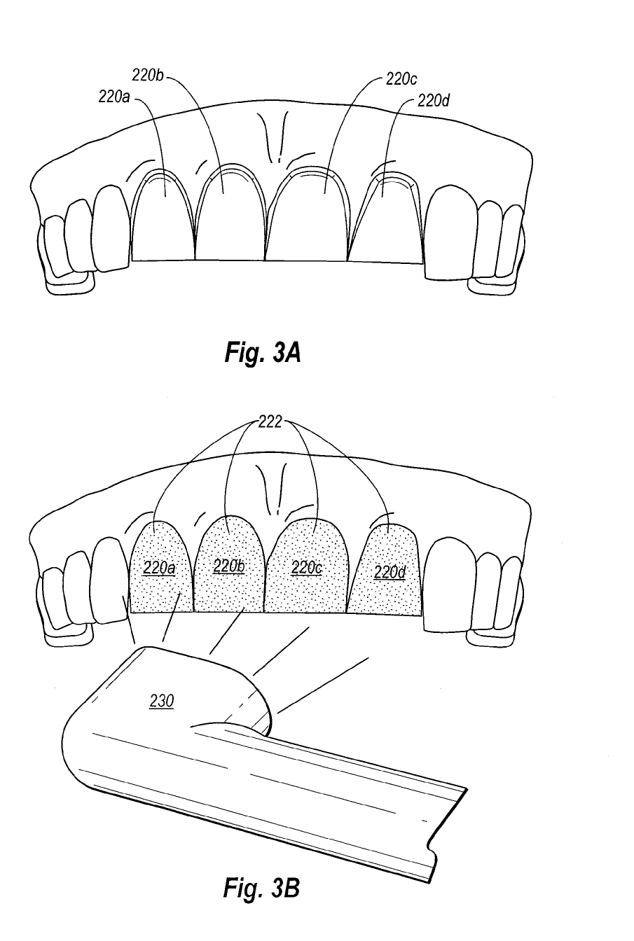

FIG. 2 illustrates an exemplary kit 150 including a plurality of sub-kits. Illustrated sub-kit 150a includes one veneer appliance for each of the 16 basic VITA LUMIN shade/intensities for use with one particular tooth (e.g., an upper first left incisor). For example, appliance 100a1 is of an A1 VITA LUMIN shade/intensity, appliance 100a2 is of an A2 VITA LUMIN shade/intensity, and so on for appliances 100a3-100d3. In the illustrated example, the sub-kit 150a forms part of a larger kit 150 including additional sub-kits 150b, 150c, and 150d. For example, sub-kits 150b-150d may include contents similar to sub-kit 150a, but each sub-kit may provide appliances configured for a different tooth position (e.g., sub-kit 150b may contain veneer appliances configured for placement over an upper second left incisor, sub-kit 150c may contain veneer appliances configured for placement over an upper first right incisor, and sub-kit 150d may contain veneer appliances configured for placement over an upper second right incisor). Kit 150 may include additional sub-kits, as desired (e.g., one sub-kit for each of the 28 tooth positions of a typical adult, each sub-kit including one each of the 16 basic VITA LUMIN shade/intensities for use with one particular tooth).

The inventive sub-kit advantageously provides a plurality of prefabricated non-custom dental appliances, each configured for placement over the same tooth, with each being of a different shade/intensity. Such a sub-kit allows a practitioner to select an appropriately shaded appliance from the sub-kit for bonding to the tooth that is it configured for bonding to. Selection of the particular appliance chosen is based upon the shade and intensity of adjacent natural teeth and/or any additional appliances to be installed at the same time. The kit including multiple sub-kits allows for selection of additional appliances with similar or identical shade/intensity characteristics to be installed onto adjacent teeth at the same time. Advantageously, this allows for consistent shade matching across the multiple appliances that are to be installed. The matching and consistency of shade achievable by the inventive kit and method is much greater as compared to what is possible when installing multiple custom appliances. In addition, the complete procedure can be performed in a single appointment, rather than requiring multiple appointments to complete the procedure. It will be appreciated that in addition to saving time, such an advantage also reduces costs.

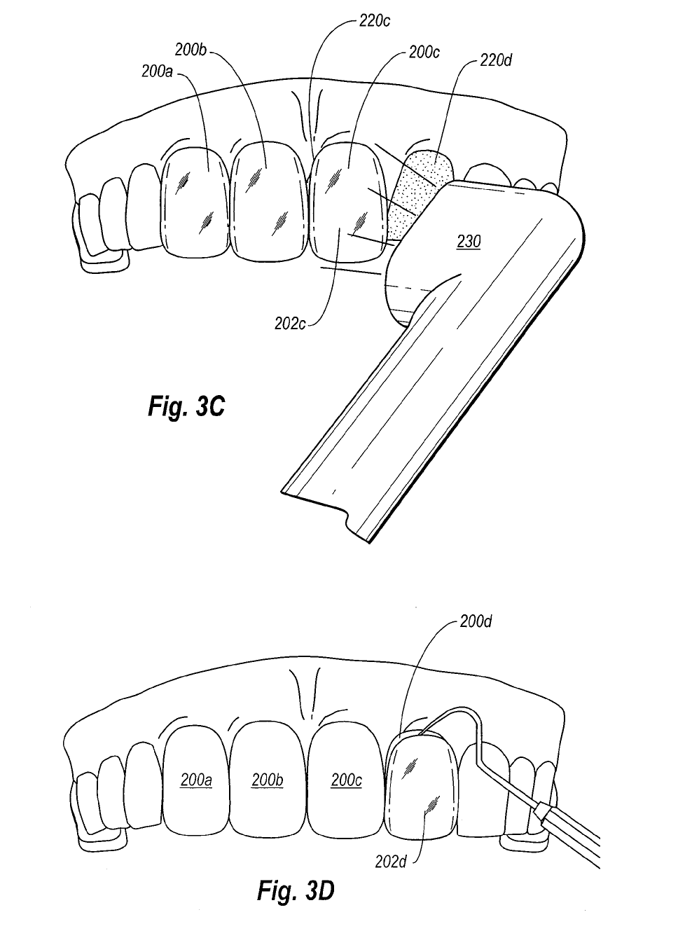

FIG. 3A is a perspective view of a person's upper dental arch where several teeth have been prepared for installation of the inventive appliances. In many instances, it is desireable to apply several veneer appliances over several adjacent mutilated and/or highly disfigured anterior teeth in this way. Upper second left incisor 220a, upper first left incisor 220b, upper first right incisor 220c, and upper second right incisor 220d have been ground down, so as to remove about 1-2 mm of the labial enamel surface of each of the incisors preparatory to installation of a pre-fabricated, non-custom veneer appliance over each tooth. The exact depth of enamel removed depends on the thickness of the composite layers or regions, the translucency, and other characteristics of the veneer appliances to be installed over each prepared tooth. In addition, the incisal edge of each of each of incisors 220a-220d may advantageously also be removed, which conceals the interface between the remaining portion of the natural tooth and the installed appliance (i.e., this portion of the interface is only visible from the lingual side of the tooth). Because the complete procedure can be performed in a single appointment, and because of the ability of the practitioner to select an appropriate appliance chair-side, often more of the natural tooth structure and underlying supporting natural coloration of the patient's teeth may be retained while also achieving good shade matching as compared to if a custom appliance is ordered (which may not match very well) from a dental lab, and which may require that additional tooth structure be removed, depending-on the thickness of the custom fabricated appliance.

As illustrated in FIG. 3B, the labial surfaces of teeth 220a-220d may be further prepared by application of an etch (not shown), a primer (not shown), and finally a bonding resin 222. A dental curing light 230 is then used to cure bonding resin 222. Referring to FIG. 3C, the dental practitioner then positions each pre-selected veneer appliance over the prepared tooth surface to which it is to be bonded, and then exposes the appliance to curing light wavelengths from dental curing light 230 so as to fully cure the composite layers or regions of each appliance, resulting in a strong bond between the veneer appliance and the underlying tooth structure. If desired, the practitioner may manipulate the composite layers and/or apply additional composite to the prepared tooth surface prior to curing. Such flexibility in the system and method allows a practitioner some degree of flexibility and customization, although such customization is not required. In FIG. 3C, veneer appliances 200a and 200b have already been cured and bonded, while veneer appliance 200c is being cured and bonded to underlying tooth 220c. Transparent or translucent form layer 202c advantageously allows the curing light wavelengths emitted from dental curing light 230 to be transmitted through form layer 202c so as to cure and bond the underlying composite layers or regions to tooth 220c. Because the practitioner is able to select a desired appliance with the patient present, much better shade matching is achieved as compared to custom appliances ordered from a dental lab and fabricated based only on a description (i.e., without the patient present).

As seen in FIG. 3D, once each appliance has been fully cured and bonded to its designated tooth, the any plastic transparent or translucent form layers may be removed from each appliance, leaving a finished veneer that provides consistent shade matching to adjacent veneers and adjacent natural teeth. In FIG. 3D, the transparent or translucent form layers have already been removed from appliances 200a-200c, while a dental tool is being used to remove form layer 202d from veneer appliance 200d.

For example, appliances 200a-200d may be selected from kit 150 (FIG. 2) including several sub-kits 150a-150d. For example, appliance 200b may be selected from sub-kit 150a, which contains many veneer appliances, each of a different shade/intensity, and each configured for placement over the upper first left incisor. Appliance 200a may be selected from sub-kit 150b, which contains veneer appliances of various shades and intensities, each configured for placement over the upper second left incisor. Appliance 200c may be selected from sub-kit 150c, which contains veneer appliances of various shades and intensities, each configured for placement over the upper first right incisor. Appliance 200d may be selected from sub-kit 150d, which contains veneer appliances of various shades and intensities, each configured for placement over the upper second right incisor.

The veneer appliances 200a-200d are selected so as to provide consistent shade matching across all four incisors, as well as good shade matching with the adjacent canines. The veneer appliances may be selected such that they each provide identical shade/intensity values (e.g., all A2). It is also within the scope of the invention to select veneer appliances that do not provide identical shade intensity values, which may be particularly advantageous where the adjacent upper left canine and upper right canine have shading and intensity characteristics very different from one another. In any case, the inventive kit and method allows a dental practitioner to quickly select, optionally manipulate (i.e., limited customization) and bond prefabricated non-custom appliances that will provide for improved shade matching of each appliance relative to adjacent appliances and/or adjacent natural teeth. The method is easily employed by practitioners of average or even below average skill to quickly achieve consistent matching across one or more installed appliances.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A prefabricated non-custom dental appliance for bonding to a person's tooth, comprising:
a form layer including a surface contoured to approximate a tooth surface, the form layer being transparent or translucent to curing light wavelengths; and
a plurality of composite regions that are at least partially uncured, at least one of the composite regions being adjacent to the transparent or translucent form layer, the plurality of composite regions having a predetermined arrangement and at least one of the plurality of composite regions differing in color from at least one other of the plurality of composite regions so as to provide a desired shade to the dental appliance in order to create a desired appearance.

2. A dental appliance as recited in claim 1, wherein the plurality of composite regions are partially cured so as to prevent the plurality of composite regions from slumping.

3. A dental appliance as recited in claim 1, wherein the plurality of composite regions consists of two composite regions.

4. A dental appliance as recited in claim 1, wherein the plurality of composite regions comprises three or more composite regions.

5. A dental appliance as recited in claim 1, wherein a composite region that is adjacent to the transparent or translucent form layer is at least semi-translucent when fully cured.

6. A dental appliance as recited in claim 1, wherein at least one of the plurality of composite regions is red brown, red yellow, gray, or reddish gray so as to simulate tooth color.

7. A dental appliance as recited in claim 1, wherein each of the plurality of composite regions comprises a composite layer, each composite layer being disposed adjacent to the transparent or translucent form layer and/or another composite layer.

8. A dental appliance as recited in claim 1, wherein the form layer comprises a separate, removable layer that is transparent or translucent to visible light wavelengths.

9. A dental appliance as recited in claim 8, wherein an interior surface of the form layer is contoured to approximate a labial tooth surface.

10. A dental appliance as recited in claim 1, wherein the form layer comprises a portion of the composite regions, the portion having sufficient rigidity to maintain a surface contour that approximates a tooth surface.

11. A kit for use in bonding one or more prefabricated non-custom dental appliances to a person's teeth, comprising:
a first prefabricated non-custom dental appliance comprising:
a first form layer including a surface contoured to approximate a tooth surface, the form layer being transparent or translucent to curing light wavelengths; and
a first plurality of composite regions that are at least partially uncured, at least one of the composite regions being adjacent to the first form layer, the first plurality of composite regions having a predetermined arrangement and at least one of the first plurality of composite regions differing in color from at least one other of the first plurality of composite regions so as to provide a desired shade to the first prefabricated non-custom dental appliance in order to create a desired appearance; and
at least a second prefabricated non-custom dental appliance comprising:
a second form layer including a surface contoured to approximate a tooth surface, the form layer being transparent or translucent to curing light wavelengths; and
a second plurality of composite regions that are at least partially uncured, at least one of the second plurality of composite regions being adjacent to the second form layer, the second plurality of composite regions having a predetermined arrangement and at least one of the second plurality of composite regions differing in color from at least one other of the second plurality of composite regions so as to provide a desired shade to the second prefabricated non-custom dental appliance in order to create a desired appearance.

12. A kit as recited in claim 11, wherein the first plurality of composite regions of the first prefabricated non-custom dental appliance provide a first shade and the second plurality of composite regions of the second prefabricated non-custom dental appliance provide a second shade different from the first shade.

13. A kit as recited in claim 11, wherein the first form layer of the first prefabricated non-custom dental appliance includes a surface contoured to approximate a first tooth surface and the second form layer of the second prefabricated non-custom dental appliance includes a surface contoured to approximate a second tooth surface different from the first tooth surface.

14. A kit as recited in claim 13, wherein the surface of the first form layer is contoured to approximate the labial surface of a tooth of the upper dental arch.

15. A kit as recited in claim 13, wherein the surface of the first form layer is contoured to approximate the labial surface of a tooth of the lower dental arch.

16. A kit as recited in claim 13, wherein the surface of the first form layer is contoured to approximate the labial surface of a tooth selected from the group consisting of a first incisor, a second incisor, a canine, a first bicuspid, a second bicuspid, a first molar, and a second molar.

17. A method of making a prefabricated non-custom dental appliance for bonding to a person's tooth, comprising:
providing a molding form layer including an interior surface contoured to approximate a tooth surface;
determining an arrangement of a plurality of composite regions, at least one of the plurality of composite regions differing in color from at least one other of the plurality of composite regions, the arrangement being configured to provide a desired shade to the dental appliance in order to create a desired appearance;
applying a plurality of at least partially uncured composite regions over the transparent or translucent form layer so that at least one of the plurality of composite regions is adjacent to the molding form layer, at least one of the composite regions differing in color from at least one other of the plurality of composite regions, the plurality of composite regions being applied according to a predetermined arrangement so as to provide a desired shade to the dental appliance in order to create a desired appearance.

18. A method as recited in claim 17, further comprising exposing the plurality of at least partially uncured composite regions to curing light wavelengths so as to partially cure the plurality of composite regions without fully curing the plurality of composite regions.

19. A method of bonding a prefabricated non-custom dental appliance to a person's tooth, comprising:
providing a kit as recited in claim 11;
identifying a prefabricated non-custom dental appliance from the kit that includes a form layer including a surface contoured to approximate a tooth surface of a desired tooth, the prefabricated non-custom dental appliance identified providing a desired shade to the dental appliance in order to create a desired appearance;
preparing a tooth surface for bonding to the prefabricated non-custom dental appliance identified;
positioning the prefabricated non-custom dental appliance identified over a prepared tooth surface; and
bonding the prefabricated non-custom dental appliance to the prepared tooth surface.

20. A method as recited in claim 19, wherein the step of preparing a tooth surface for bonding comprises removing a portion of tooth enamel, etching an underlying tooth surface, and applying a bonding resin to the tooth surface.

21. A method as recited in claim 19, wherein the step of bonding the prefabricated non-custom dental appliance to the prepared tooth surface comprises fully curing the plurality of composite regions of the appliance through the form layer.

22. A method as recited in claim 19, further comprising manipulating the plurality of composite regions prior to bonding the prefabricated non-custom dental appliance to the prepared tooth surface.
